(19) United States
(12) Patent Application Publication
(10) Pub. No.: US 2022/0222617 A1
(43) Pub. Date: Jul. 14, 2022

(54) INFORMATION PROCESSING APPARATUS, INFORMATION PROCESSING METHOD, AND INFORMATION PROCESSING SYSTEM

(71) Applicant: KDDI CORPORATION, Tokyo (JP)

(72) Inventors: Masayuki TACHIIWA, Tokyo (JP); Tomoaki MATSUKI, Tokyo (JP); Kyohei TSUJI, Tokyo (JP)

(73) Assignee: KDDI CORPORATION, Tokyo (JP)

(21) Appl. No.: 17/410,570

(22) Filed: Aug. 24, 2021

(30) Foreign Application Priority Data
Jan. 14, 2021 (JP) 2021-004539

(51) Int. Cl. G06Q 10/08; G08G 5/00; B64C 39/02

(52) U.S. Cl. CPC G06Q 10/0833; B64C 2201/128; B64C 39/024; G08G 5/003

(57) ABSTRACT

An information processing apparatus includes an article specification unit specifying a delivery destination of a first delivery target article which is a delivery target desired by a user, and a first feature of the first delivery target article, a time specification unit that specifies one or more dates and times scheduled for a flight, which can deliver the first delivery target article specified based on the first feature and flying object information indicating a feature of an article that can be delivered by a flying object scheduled to fly to the delivery destination, to fly to the delivery destination, an information transmission unit transmitting the one or more dates and times to an information terminal of the user, and an output unit receiving date and time information indicating a date and time selected from the one or more dates and times and outputs the received date and time information.

### BACKGROUND OF THE INVENTION

### Field of the Invention

The present invention relates to an information processing apparatus, an information processing method, and an information processing system.

Priority is claimed on Japanese Patent Application No. 2021-004539, filed on Jan. 14, 2021, the content of which is incorporated herein by reference.

### Description of Related Art

In the related art, a delivery system for delivering an article to a delivery destination using an unmanned flying object is known (see, for example, Japanese Unexamined Patent Application, First Publication No. 2016-153337).

### SUMMARY OF THE INVENTION

In a case where a technique in the related art is used, an unmanned flying object is not able to deliver an article when the weight or the size of the article exceeds the deliverable weight or size of the unmanned flying object. As a result, there has been a problem that the article cannot be delivered at the timing desired by a user at the delivery destination.

Therefore, the present invention has been made in view of these points, and an object of the present invention is to ensure that an article is delivered at the timing desired by a user at a delivery destination.

An information processing apparatus according to a first aspect of the present invention includes: an article specification unit that specifies a delivery destination of a first delivery target article which is a delivery target desired by a user, and a first feature of the first delivery target article; a time specification unit that specifies one or more dates and times scheduled for a flight, which is specified as capable of delivering the first delivery target article based on the first feature and flying object information, to fly to the delivery destination, the flying object information indicating a feature of an article that is configured to be delivered by a flying object scheduled to fly to the delivery destination; an information transmission unit that transmits the one or more dates and times to an information terminal of the user; and an output unit that receives date and time information indicating a date and time selected from the one or more dates and times and outputs the received date and time information.

The article specification unit may further specify a second feature of a second delivery target article, which is another delivery target article scheduled to be delivered by the flying object, and the time specification unit may specify one or more dates and times scheduled for a flight, which is configured to deliver the first delivery target article to a delivery destination together with the second delivery target article by comparing the first feature and the second feature with the feature indicated by the flying object information, to fly to the delivery destination.

The article specification unit may specify a first weight or a first size of the first delivery target article, and a second weight or a second size of the second delivery target article, and the time specification unit may specify the one or more dates and times scheduled for the flight, which is specified based on a relationship between a total weight of the first weight and the second weight, and a maximum weight of the article that is configured to be delivered by the flying object, or a relationship between a total size of the first size and the second size, and a maximum size of the article that is configured to be delivered by the flying object, to fly to the delivery destination.

The article specification unit may specify a first shape of the first delivery target article and a second shape of the second delivery target article, and the time specification unit may specify the one or more dates and times scheduled for the flight, which is further specified based on a relationship between the first shape and the second shape, to fly to the delivery destination.

The article specification unit may further specify a first type of the first delivery target article and a second type of the second delivery target article, and the time specification unit may specify the one or more dates and times scheduled for the flight, which is further specified based on whether or not the first type and the second type are types configured to be loaded, to fly to the delivery destination.

The article specification unit may specify at least one of the first weight and the first size of the first delivery target article as the first feature, and the time specification unit may specify the one or more dates and times scheduled for the flight, which is specified based on at least one of the first weight and the first size and at least one of a weight and a size of the article that is configured to be delivered by the flying object indicated by the flying object information, to fly to the delivery destination.

The article specification unit may further specify a weight of a return article to be loaded while the flying object flies on a return route from the delivery destination to a delivery source or a section from the delivery destination to a destination different from the delivery source, a distance between the delivery source and the delivery destination, or a distance between the delivery destination and the destination, and the time specification unit may specify the one or more dates and times scheduled for the flight, which is specified based on a remaining battery level of the flying object, the weight of the return article, and the distance, to fly to the delivery destination.

Among a plurality of flying objects scheduled to fly to the delivery destination, the time specification unit may specify a plurality of dates and times scheduled for a plurality of flying objects, which are configured to deliver the first delivery target article, to fly to the delivery destination, and the information transmission unit may transmit the plurality of dates and times to the information terminal.

A storage unit that stores article information indicating features of each of a plurality of articles in association with the plurality of articles may be further included, the first delivery target article may be an article for which the user requested delivery among the plurality of articles, and the article specification unit may specify the first feature of the first delivery target article based on the article information stored in the storage unit in association with the article corresponding to the first delivery target article.

The storage unit that stores the flying object information and the one or more dates and times, which are scheduled for the flight to fly to the delivery destination, in association with each other may be further included, and by referring to the flying object information and the one or more dates and times stored in the storage unit, the time specification unit may specify one or more dates and times scheduled for the flight to fly to the delivery destination.

An information processing method according to a second aspect of the present invention, the method for causing a computer to execute processing of: specifying a delivery destination of a first delivery target article which is a delivery target desired by a user, and a first feature of the first delivery target article; specifying one or more dates and times scheduled for a flight, which is specified as capable of delivering the first delivery target article based on the first feature and flying object information, to fly to the delivery destination, the flying object information indicating a feature of an article that is configured to be delivered by a flying object scheduled to fly to the delivery destination; transmitting the one or more dates and times to an information terminal of the user; and receiving date and time information indicating a date and time selected from the one or more dates and times and outputting the received date and time information.

An information processing system according to a third aspect of the present invention includes: an information processing apparatus that specifies a date and time of a flight that is configured to deliver a delivery target article which is a delivery target desired by a user, to a delivery destination; and an information terminal that selects the date and time for requesting delivery of the delivery target article among the dates and times specified by the information processing apparatus, in which the information processing apparatus includes an article specification unit that specifies the delivery destination of the delivery target article and a feature of the delivery target article, a time specification unit that specifies one or more dates and times scheduled for the flight, which is specified as capable of delivering the delivery target article based on the feature of the delivery target article and flying object information, to fly to the delivery destination, the flying object information indicating a feature of an article that is configured to be delivered by a flying object scheduled to fly to the delivery destination, an information transmission unit that transmits the one or more dates and times to the information terminal of the user, and an output unit that receives date and time information indicating a date and time selected from the one or more dates and times and outputs the received date and time information, and the information terminal includes an information reception unit that receives the one or more dates and times, a display unit that displays the received one or more dates and times, and an information transmission unit that transmits the date and time information selected by the user among the one or more dates and times.

According to the present invention, there is an effect that an article is delivered at the timing desired by a user at a delivery destination.

### BRIEF DESCRIPTION OF THE DRAWINGS

FIG. 1 is a block diagram illustrating an information processing system according to an embodiment of the present invention.

FIG. 2 is a block diagram illustrating an information terminal according to the embodiment.

FIG. 3 is a block diagram illustrating an information processing apparatus according to the embodiment.

FIG. 4 is a sequence chart illustrating an operation of the information processing system according to the embodiment.

FIG. 5 is a flowchart illustrating an operation of the information processing apparatus according to the embodiment.

### DETAILED DESCRIPTION OF EMBODIMENTS

Overview of Information Processing System S

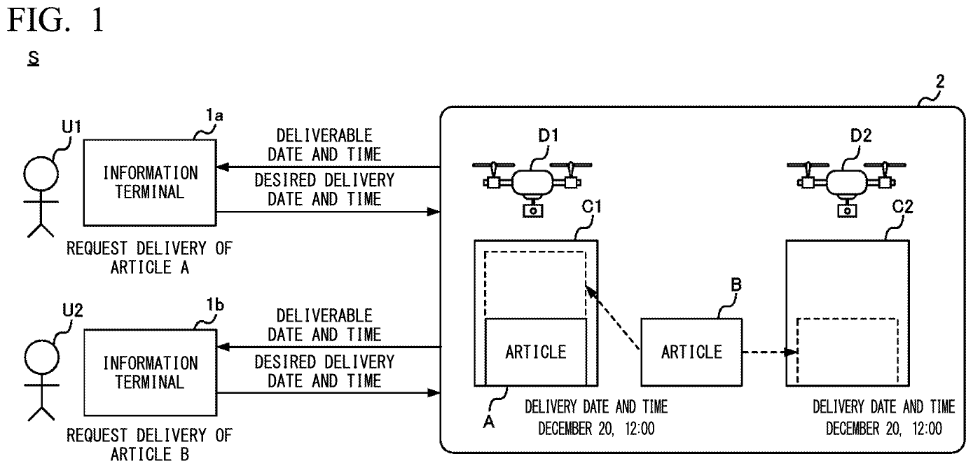

FIG. 1 is a diagram illustrating a configuration of an information processing system S. The information processing system S includes a plurality of information terminals 1 (1a, 1b) and an information processing apparatus 2. The information terminal 1 is, for example, a computer or a smartphone. The information processing apparatus 2 is, for example, a computer. The information processing apparatus 2 may be configured with a single information processing apparatus or may be a plurality of information processing apparatuses such as a cloud-type server. The information terminal 1 and the information processing apparatus 2 can transmit and receive data via a network such as the Internet. The network may include a wireless network.

The information processing system S is a system that enables a user U who uses the information terminal 1 to request delivery of an article (hereinafter, referred to as a “delivery target article”) that is desired to be delivered to a delivery destination. In the information processing system S, when the information processing apparatus 2 receives a delivery request including information related to the delivery target article from the information terminal 1, one or more dates and times (deliverable dates and times) at which the delivery target article can be delivered, are transmitted to the information terminal 1. The information terminal 1 displays the received one or more dates and times and allows the user U to select a desired delivery date and time. The information terminal 1 transmits the desired delivery date and time selected by the user U to the information processing apparatus 2.

FIG. 1 illustrates a case where a user U2 of an information terminal 1b requests delivery of an article B after it is decided to deliver an article A, in which a user UI of an information terminal 1a requested for delivery, by a flight D1. The delivery date and time is the time scheduled for the flight D to arrive at the delivery destination. The flight D is, for example, a flight that flies at regular intervals for delivering articles and includes a container C for loading the articles. Flying objects flying on each of a plurality of flights D (D1, D2) may be the same or may be different from each other. The flying object is, for example, a drone, but may be another type of flying object as long as the flying object can deliver the delivery target article.

As illustrated in FIG. 1, the user U2 requests the delivery of the article B by operating the information terminal 1b. The information terminal 1b notifies the information processing apparatus 2 of the delivery request information including the delivery destination of the article B and the feature of the article B input by the user U2 by operating the information terminal 1b. The feature of the article B is, for example, at least one of the weight, size, shape, and loadability of the article B. The size is information indicating, for example, the vertical width, the horizontal width, and the height of the article.

Although the details will be described later, the information processing apparatus 2 may have an article database in which the features of various articles are registered in association with each other instead of the information terminal 1b transmitting the features of the article B. In this case, the information terminal 1b transmits, for example, an article number or a model number of the article B, which is information for specifying the article B. The information processing apparatus 2 acquires the feature of the article B associated with the article number or the model number of the article B by referring to the article database.

The information processing apparatus 2 specifies the flight D including a container C capable of accommodating the weight or the size of the article B among the flights D flying to the delivery destination of the article B. The information processing apparatus 2 transmits the delivery date and time of the specified flight D to the information terminal 1b. The information processing apparatus 2 specifies, for example, that the weight or the size of the article B can be accommodated in the container C2 included in the flight D2 and transmits “December 20, 13:00”, which is the delivery date and time of the flight D2, to the information terminal 1b as one of the deliverable dates and times.

For example, like the flight D1, when it is decided to deliver the article A before the delivery request of the article B, the information processing apparatus 2 determines whether or not the article B can be accommodated in the container C1 together with the article A based on the feature of the article A, the feature of the article B, and the feature of the container C1. The feature of article A includes, for example, at least one of the weight or the size of the article A, information about whether or not article A can be loaded on another article, and information about whether or not the article A can be loaded in contact with the other article. The feature of the container C1 includes, for example, at least one of the weight that the container C1 can be loaded, the volume of the container C1, and the shape of the container C1. When it is determined that the article B can be accommodated in the container C1 by loading the article B on the top surface of the article A based on the features of each of the article A and the article B and the feature of the container C1, the information processing apparatus 2 specifies that the flight D1 is a flight that can deliver the article B and transmits “December 20, 12:00”, which is the delivery date and time of the flight D1, to the information terminal 1b as one of the deliverable dates and times.

The information terminal 1b receives, for example, “December 20, 12:00”, which is the delivery date and time of the flight D1, and “December 20, 13:00”, which is the delivery date and time of the flight D2, from the information processing apparatus 2 as the deliverable dates and times. The information terminal 1b selects a date and time for requesting delivery of the delivery target article among the dates and times specified by the information processing apparatus 2 in response to the operation of the user U2. The information terminal 1b transmits the date and time selected by the user U2 among the one or more delivery dates and times received from the information processing apparatus 2, to the information processing apparatus 2.

When the information terminal 1 and the information processing apparatus 2 operate as described above, the information terminal 1 displays the delivery date and time of the delivery target article received from the information processing apparatus 2. The information terminal 1 transmits the delivery date and time selected by the user U among the displayed delivery dates and times, to the information processing apparatus 2. As a result, the user U who requests the delivery of the article can select the desired date and time for delivery among the dates and times when the flight D can deliver.

### Configuration of Information Terminal 1

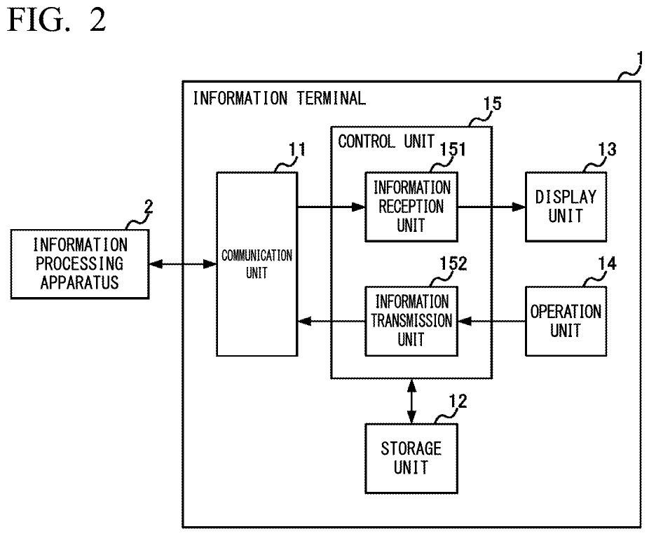

FIG. 2 is a diagram illustrating a configuration of the information terminal 1. The information terminal 1 includes a communication unit 11, a storage unit 12, a display unit 13, an operation unit 14, and a control unit 15. The control unit 15 includes an information reception unit 151 and an information transmission unit 152.

The communication unit 11 includes a communication device for receiving information via the network. The communication device is, for example, a local area network (LAN) controller or a wireless LAN controller. The storage unit 12 includes a storage medium such as a read only memory (ROM), a random access memory (RAM), and a solid state drive (SSD). The storage unit 12 stores a program executed by the control unit 15.

The display unit 13 includes a display device such as a liquid crystal display or an organic electro luminescence (EL). The display unit 13 displays the one or more dates and times received from the information processing apparatus 2 by the information reception unit 151. The one or more dates and times are dates and times when the delivery target article, in which the user U of the information terminal 1 requested for delivery, can be delivered. The operation unit 14 is, for example, a touch panel, and receives an input operation from the user U of the information terminal 1. The operation unit 14 receives an operation for the user U of the information terminal 1 to request delivery of the delivery target article. The operation unit 14 receives the operation of selecting a delivery date and time desired by the user U of the information terminal 1 among the one or more dates and times displayed by the display unit 13.

The control unit 15 is, for example, a central processing unit (CPU). The control unit 15 functions as the information reception unit 151 and the information transmission unit 152 by executing a program stored in the storage unit 12. The information reception unit 151 receives one or more dates and times from the information processing apparatus 2. The information reception unit 151 causes the display unit 13 to display a screen for selecting a delivery date and time based on the received one or more dates and times.

The information transmission unit 152 transmits the delivery request information including the delivery destination of the delivery target article and the feature of the delivery target article to the information processing apparatus 2 based on the operation for requesting the delivery of the delivery target article received by the operation unit 14. The information transmission unit 152 transmits the date and time information selected by the user U among one or more dates and times displayed by the display unit 13. The information transmission unit 152 transmits the delivery date and time selected by the user U to the information processing apparatus 2 based on the fact that the operation unit 14 received that the user U of the information terminal 1 selected the delivery date and time. Configuration of Information Processing Apparatus 2

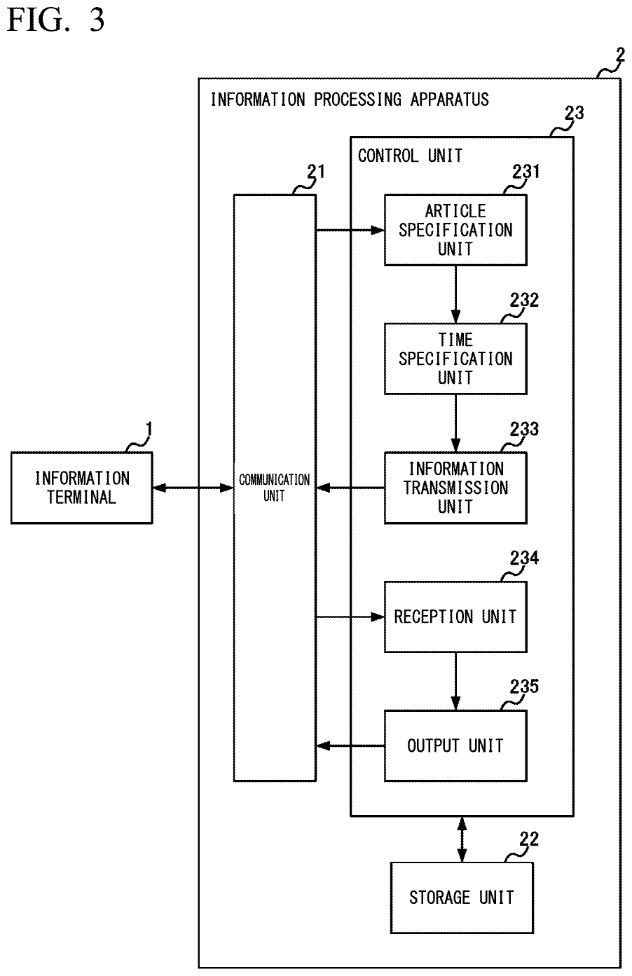

FIG. 3 is a diagram illustrating a configuration of the information processing apparatus 2. The information processing apparatus 2 includes the communication unit 21, the storage unit 22, and the control unit 23. The control unit 23 includes an article specification unit 231, a time specification unit 232, an information transmission unit 233, a reception unit 234, and an output unit 235. The communication unit 21 includes a communication device for receiving information via the network. The communication device is, for example, a LAN controller or a wireless LAN controller.

The storage unit 22 includes a storage medium such as a ROM, a RAM, and an SSD. The storage unit 22 stores a program executed by the control unit 23. The storage unit 22 may store the flying object information and one or more dates and times, which is scheduled for the flight D to fly to the delivery destination, in association with each other. The flying object information is, for example, information indicating the weight or the size that the flying object can deliver. The storage unit 22 stores the weight or the size that the flying object indicated by the flying object information can deliver and the delivery date and time of the flight D to which the flying object flies, in association with each other.

The control unit 23 is, for example, a CPU. The control unit 23 functions as the article specification unit 231, the time specification unit 232, the information transmission unit 233, the reception unit 234, and the output unit 235 by executing a program stored in the storage unit 22.

The article specification unit 231 specifies the delivery destination of the first delivery target article which is the delivery target desired by the user U, and the first feature of the first delivery target article. The first delivery target article is a delivery target article that is the target for the information processing apparatus 2 to specify the deliverable date and time. For example, in the example illustrated in FIG. 1, when it is necessary to specify the deliverable date and time of the article B, in which the user U2 requested for delivery, the article B becomes the first delivery target article. The first feature is, for example, information necessary for specifying the delivery date and time of the flight D that can deliver the first delivery target article. The article specification unit 231 notifies the time specification unit 232 of the specified first feature.

The article specification unit 231 specifies at least one of the first weight and the first size of the first delivery target article, for example, as the first feature. For example, the delivery request information received from the information terminal 1b via the communication unit 21 includes information indicating the first feature. The article specification unit 231 specifies the delivery destination of the first delivery target article and at least one of the first weight and the first size of the first delivery target article based on the delivery request information received from the information terminal 1 via the communication unit 21, for example.

The article specification unit 231 may further specify the second feature of the second delivery target article, which is another delivery target article scheduled to be delivered by the flying object. For example, the delivery request information received from the information terminal 1a via the communication unit 21 includes information indicating the second feature. For example, when the article B illustrated in FIG. 1 is the first delivery target article, the second delivery target article is the article A. The second feature is, for example, at least one of a second weight or a second size of the second delivery target article. When the article A is the second delivery target article, the article specification unit 231 specifies the delivery destination included in the delivery request information of the article A received from the information terminal 1a and at least one of the second weight and the second size. The article specification unit 231 notifies the time specification unit 232 of the specified second feature.

The article specification unit 231 may specify the first weight or the first size of the first delivery target article and the second weight or the second size of the second delivery target article. The article specification unit 231 specifies, for example, the first weight or the first size of the first delivery target article and specifies the second weight or the second size of the second delivery target article to be delivered to the same delivery destination as the first delivery target article. For example, when the first delivery target article is the article B, the article specification unit 231 specifies the first weight or the first size received from the information terminal 1b and the second weight or the second size received from the information terminal 1a.

The article specification unit 231 may specify a first shape of the first delivery target article and a second shape of the second delivery target article. The shape of the delivery target article is information indicating whether or not the delivery target article is a hexahedron such as a rectangular parallelepiped, or whether or not the delivery target article has a curved surface such as a cylinder or a sphere. The article specification unit 231 specifies the shape of the delivery target article by receiving the information indicating the shape of the delivery target article from the information terminal 1 in which the delivery request information of the delivery target article is transmitted.

The article specification unit 231 may further specify a first type of the first delivery target article and a second type of the second delivery target article. The type of the delivery target article is, for example, information indicating that the top surface and the bottom surface of the delivery target article are switched or whether or not it is permissible to invert the delivery target article, or information indicating whether or not another delivery target article may be loaded on the top surface of the delivery target article. The article specification unit 231 specifies the type of the delivery target article by receiving information indicating the type of the delivery target article from the information terminal 1 in which the delivery request information of the delivery target article is transmitted.

The time specification unit 232 specifies one or more deliverable dates and times scheduled for the flight D, which can deliver the first delivery target article that is specified based on the flying object information that indicates the feature of the article that can be delivered by the flying object scheduled to fly to the delivery destination and the first feature, to arrive at the delivery destination. The flying object information is information indicating the weight or the size of an article that can be delivered by each of a plurality of flying objects, and is, for example, information about the maximum load weight of the flying object or the size of the inside of the container C included in the flying object. The date and time specified by the time specification unit 232 may indicate the month, date, and time as in the delivery date and time of the flight D1 illustrated in FIG. 1, or indicate the time zone as in “12:00 to 14:00”. The time specification unit 232 specifies the delivery date and time of the flight D that can deliver the first delivery target article based on the maximum load weight or size of the flying object indicated by the flying object information and the weight or the size of the first delivery target article indicated by the first feature.

The time specification unit 232 specifies one or more dates and times scheduled for the flight to fly to the delivery destination by referring to, for example, the flying object information and one or more dates and times stored in the storage unit 22. The time specification unit 232 specifies the flight D that can deliver the first delivery target article, based on the flying object information stored in the storage unit 22 and the first feature of the first delivery target article specified by the article specification unit 231, for example. The time specification unit 232 specifies the delivery date and time of the flight D by referring to one or more dates and times associated with the flying object information indicating the flight D stored in the storage unit 22.

The time specification unit 232 specifies one or more dates and times scheduled for the flight, which is specified, for example, based on at least one of the first weight and the first size indicated by the first feature and at least one of the weight and size of the article that the flying object indicated by the flying object information can deliver, to fly to the delivery destination. The time specification unit 232 specifies the delivery date and time of the flight D in which at least one of the flying object associated with the flying object information indicating the maximum load weight equal to or larger than the first weight and the flying object associated with the flying object information indicating the size of the container C equal to or larger than the first size, flies to the delivery destination, for example.

By operating the time specification unit 232 in this way, the information processing apparatus 2 can display one or more delivery dates and times of the flight D that can deliver the delivery target article, in which the user U of the information terminal 1 requested for delivery, on the information terminal 1. As a result, the user U of the information terminal 1 can select the date and time when the user U wants the delivery target article to be delivered from the delivery date and time displayed on the information terminal 1 by the information processing apparatus 2.

By comparing the first feature and the second feature with the feature indicated by the flying object information, the time specification unit 232 may specify one or more dates and times scheduled for a flight, which can deliver the first delivery target article to the delivery destination together with the second delivery target article, to fly to the delivery destination. The first feature is, for example, the feature of the article B illustrated in FIG. 1, for example, and indicates at least one of the weight or the size of the article B. The second feature is a feature of another article different from the article

B, for example, and indicates at least one of the weight or the size of the other article different from the article B. The feature indicated by the flying object information indicates, for example, the weight or the size that each of the plurality of flights D illustrated in FIG. 1 can deliver. The time specification unit 232 specifies the flight D that can deliver the article B and specifies the delivery date and time of the flight D based on the feature of the article B in which the user U2 requested for delivery, the feature of another article different from the article B, and the feature of the flying object to which the article is delivered, for example.

The time specification unit 232 may specify one or more dates and times scheduled for the flight, which is specified based on a relationship between a total weight of the first weight and the second weight, and the maximum weight of the article that can be delivered by the flying object, or a relationship between a total size of the first size and the second size, and the maximum size of the article that can be delivered by the flying object, to fly to the delivery destination. The time specification unit 232 calculates a total weight, which is a total of, for example, the first weight of the first delivery target article specified by the article specification unit 231 and the second weight of the second delivery target article specified by the article specification unit 231. The time specification unit 232 calculates a total size, which is a total of, for example, the first size of the first delivery target article specified by the article specification unit 231 and the second size of the second delivery target article specified by the article specification unit 231.

The time specification unit 232 specifies the delivery date and time of the flight D in which the flying object associated with the flying object information indicating the maximum load weight equal to or larger than the total weight or the flying object associated with the flying object information indicating the size of the container C equal to or larger than the total size, flies to the delivery destinations of the first delivery target article and the second delivery target article, for example. By operating the time specification unit 232 in this way, the time specification unit 232 can specify the delivery date and time of the flight D that can simultaneously deliver a plurality of delivery target articles.

The time specification unit 232 may specify one or more dates and times scheduled for the flight, which is further specified based on the relationship between the first shape and the second shape, to fly to the delivery destination. The time specification unit 232 specifies the flight D that can deliver the first delivery target article based on the first shape of the first delivery target article specified by the article specification unit 231 and the second shape of the second delivery target article specified by the article specification unit 231, and specifies the delivery date and time of the flight D.

For example, the article specification unit 231 specifies that the second shape, which is the shape of the article A illustrated in FIG. 1, is spherical. In this case, even when the total weight of the article A and the article B is equal to or less than the maximum load weight of the flight D1, the time specification unit 232 determines that the article B cannot be delivered by the flight D1 because the article B cannot be loaded on the top surface of the article A in a stable state. Subsequently, the time specification unit 232 specifies “December 20, 13:00”, which is the delivery date and time of the flight D2 when the flight D2 can deliver the article B.

On the other hand, when the article specification unit 231 specifies that the shape of the article A is a rectangular parallelepiped and does not have a curved surface, the time specification unit 232 determines that the article B can be delivered by the flight D1 because the article B can be stably loaded on the top surface of the article A. Subsequently, when the flight D2 can deliver the article B, the time specification unit 232 specifies “December 20, 12:00”, which is the delivery date and time of the flight D1, and “December 20, 13:00”, which is the delivery date and time of the flight D2.

By operating the time specification unit 232 in this way, the time specification unit 232 can prevent the date and time that cannot be delivered due to the shape restriction from being specified as the deliverable date and time. As a result, the time specification unit 232 can specify the delivery date and time of the flight D in which the delivery target article is less likely to be damaged even when the delivery target article inside the container C shakes due to the shaking during flight, for example.

The time specification unit 232 may specify one or more dates and times scheduled for the flight, which is further specified based on whether or not the first type and the second type that indicate the condition for loading the delivery target article are the types that can be loaded, to fly to the delivery destination. The time specification unit 232 specifies the flight D that can deliver the first delivery target article based on whether or not the first type of the first delivery target article specified by the article specification unit 231 and the second type of the second delivery target article specified by the article specification unit 231 indicate that those articles are delivery target articles that can be loaded, and specifies the delivery date and time of the flight D.

For example, the article specification unit 231 specifies that the second type, which is the type of the article A illustrated in FIG. 1, indicates that another article can be loaded on the top surface of the article A, and specifies that the first type, which is the type of article B, indicates that the article B can be loaded on the other article. In this case, the time specification unit 232 specifies the flight D1 that can deliver the article B by loading the article B on the top surface of the article A and specifies the delivery date and time of the flight D.

On the other hand, when the article specification unit 231 specifies that the second type, which is the type of the article A, indicates that another article cannot be loaded on the top surface of the article A, the time specification unit 232 determines that the flight D1 cannot deliver the article B. By operating the time specification unit 232 in this way, the time specification unit 232 can specify the delivery date and time of the flight D that meets the loading condition of the delivery target article. As a result, the time specification unit 232 can prevent, for example, the delivery target article being delivered from being crushed and damaged by the weight of the other delivery target article.

The time specification unit 232 may specify a plurality of dates and times scheduled for a plurality of flying objects, which can deliver the first delivery target article, to fly to the delivery destination among a plurality of flying objects scheduled to fly to the delivery destination. The plurality of dates and times specified by the time specification unit 232 may be the same or may be different from each other. For example, when the plurality of flying objects that can deliver the first delivery target article are specified based on the first feature of the first delivery target article and the flying object information, the time specification unit 232 specifies the delivery date and time of the plurality of flights D in which the plurality of flying objects fly to the delivery destination.

By operating the time specification unit 232 in this way, the time specification unit 232 can increase the number of flights D that specify that the delivery target article can be delivered. As a result, since the number of selectable delivery date and time candidates increases, the user U who requested delivery can easily select a date and time close to the desired date and time for delivery.

The information transmission unit 233 transmits one or more dates and times specified by the time specification unit 232 to the information terminal 1 of the user U. The information transmission unit 233 transmits the delivery date and time of the flight D that can deliver the delivery target article specified by the time specification unit 232 to the information terminal 1 used by the user U who requested the delivery of the delivery target article. For example, when the time specification unit 232 specifies a plurality of delivery dates and times, the information transmission unit 233 transmits the plurality of dates and times to the information terminal.

The reception unit 234 receives the delivery date and time selected by the user U from the information terminal 1 used by the user U who requested the delivery. The reception unit 234 receives the delivery date and time selected by the user U of the information terminal 1 among the plurality of delivery dates and times transmitted by the information transmission unit 233 to the information terminal 1.

The output unit 235 receives the date and time information indicating the date and time selected from one or more dates and times and outputs the received date and time information. The output unit 235 receives the delivery date and time selected by the user U of the information terminal 1 from one or more dates and times via the reception unit 234 and outputs the delivery date and time. The output unit 235 outputs the delivery date and time, for example, to the flying object that delivers the delivery target article requested by the user U, the information processing apparatus such as a server that manages the flying object, a display used by an administrator who manages the flying object, or a printer used by the administrator who manages the flying object.

### Operation Sequence of Information Processing System S

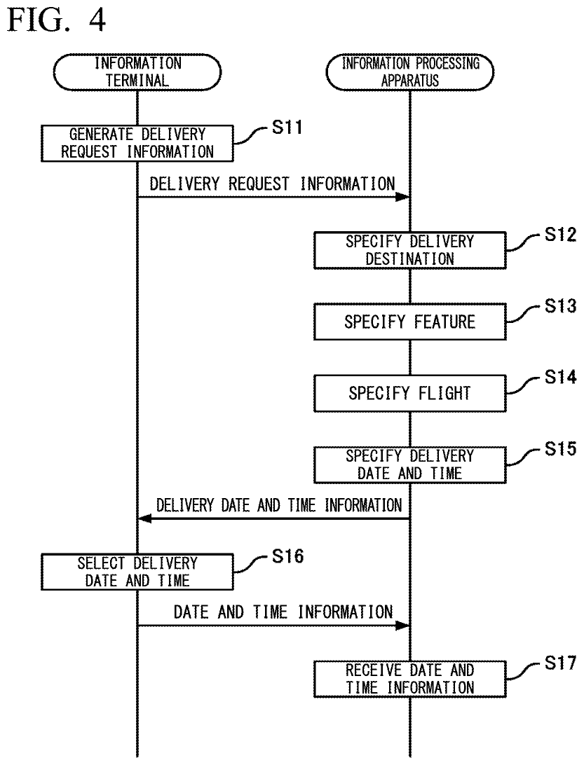

FIG. 4 is a sequence diagram illustrating an example of an operation flow of the information processing system S. The sequence diagram illustrated in FIG. 4 illustrates the operation flow when the user U of the information terminal 1 selects the delivery time of the delivery target article requested by the user U of the information terminal 1 for delivery.

In the information terminal 1, the information transmission unit 152 generates the delivery request information including the delivery destination of the delivery target article and the feature of the delivery target article (S11) and transmits the delivery request information to the information processing apparatus 2. In the information processing apparatus 2, the article specification unit 231 specifies the delivery destination included in the received delivery request information (S12). The article specification unit 231 specifies the weight or the size, which is the feature of the delivery target article included in the received delivery request information (S13).

In the information processing apparatus 2, the time specification unit 232 specifies the flight D flying to the delivery destination that is specified by the article specification unit 231 (S14). The time specification unit 232 specifies the delivery date and time of the flight D that can deliver the delivery target article of the weight or the size specified by the article specification unit 231 among the specified flight D (S15). In the information processing apparatus 2, the information transmission unit 233 transmits the delivery date and time information indicating the delivery date and time of the flight D specified by the time specification unit 232 to the information terminal 1.

In the information terminal 1, the display unit 13 displays the delivery date and time indicated by the delivery date and time information received from the information processing apparatus 2. The operation unit 14 receives an operation in which the user U of the information terminal 1 selects a delivery date and time (S16). The information transmission unit 152 transmits the date and time information indicating the delivery date and time selected by the user U of the information terminal 1 to the information processing apparatus 2. In the information processing apparatus 2, the reception unit 234 receives the date and time information transmitted by the information terminal 1 (S17).

### Flowchart of Information Processing Apparatus 2

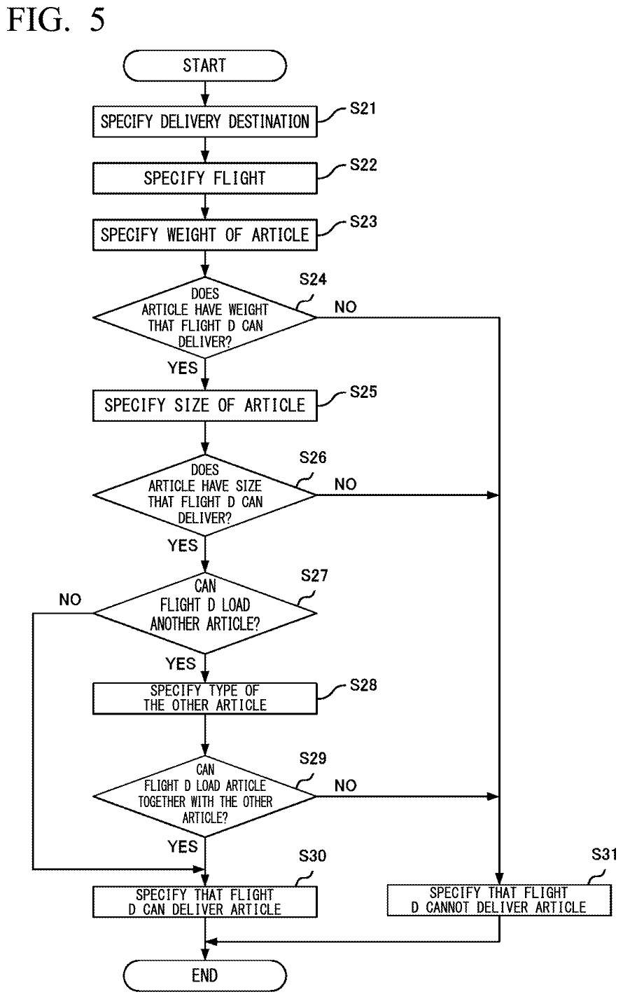

FIG. 5 is a flowchart illustrating an example of an operation of the information processing apparatus 2. The flowchart illustrated in FIG. 5 illustrates the operations corresponding to S12 to S14 of the sequence illustrated in FIG. 4. The flowchart shown in FIG. 5 illustrates an operation of determining whether or not the flight D can deliver the delivery target article requested by the user U of the information terminal 1 based on the delivery request information received by the information processing apparatus 2 from the information terminal 1.

The article specification unit 231 specifies the delivery destination included in the delivery request information received from the information terminal 1 (S21). The time specification unit 232 specifies the flight D scheduled to fly to the specified delivery destination by referring to the flying object information (S22).

The article specification unit 231 specifies the weight of the delivery target article included in the delivery request information (S23). The article specification unit 231 determines whether or not the size of the delivery target article can be delivered. When it is determined that the maximum load weight of the flight D is equal to or less than the weight of the delivery target article (NO in S24), the time specification unit 232 specifies that the delivery target article cannot be delivered by the flight D (S31). On the other hand, when it is determined that the maximum load weight of the flight D is equal to or larger than the weight of the delivery target article (YES in S24), the time specification unit 232 determines whether or not the size of the delivery target article can be delivered.

The article specification unit 231 specifies the size of the delivery target article (S25). When it is determined that the size of the container C of the flight D is equal to or less than the size of the delivery target article (NO in S26), the time specification unit 232 specifies that the delivery target article cannot be delivered by the flight D (S31). On the other hand, when it is determined that the size of the container C of the flight D is equal to or larger than the size of the delivery target article (YES in S26), the time specification unit 232 determines whether or not the delivery target article can be delivered together with another article different from the delivery target article.

The article specification unit 231 specifies whether or not the flight D loads the other article different from the delivery target article (S27). When the flight D does not load the other article (NO in S27), the time specification unit 232 specifies that the flight D can deliver the delivery target article (S30). On the other hand, when the flight D loads the other article (YES in S27), the time specification unit 232 specifies whether or not the flight D can deliver the delivery target article based on the type of the other article specified by the article specification unit 231 scheduled to be delivered by the flight D. The type of the article is, for example, information indicating whether or not the other article different from the article can be loaded on the article and whether or not the other article different from the article can be delivered together with the article.

The article specification unit 231 specifies the type of the other article (S28). When the delivery target article can be loaded together with the other article (YES in S29), the time specification unit 232 specifies that the flight D can deliver the delivery target article (S30). Specifically, when it is specified that the delivery target article and the other article can be delivered together based on the type of the other article that is specified by the article specification unit 231, and when the total weight and size of the delivery target article and the other article are the weight and the size that can be loaded in the container C of the flight D, the time specification unit 232 specifies that the flight D can deliver the deliverable target article.

On the other hand, when the delivery target article cannot be loaded together with the other article (NO in S29), the time specification unit 232 specifies that the flight D cannot deliver the delivery target article (S31). Specifically, when it is specified that the delivery target article and the other article can be delivered together based on the type of the other article that is specified by the article specification unit 231, and when the total weight or size of the delivery target article and the other article exceeds the weight or the size that can be loaded in container C, the time specification unit 232 specifies that the flight D cannot deliver the delivery target article.

### First Modification Example

In the above explanation, an example of an operation of specifying the delivery date and time of the flight D that can deliver the delivery target article based on the feature of the delivery target article acquired by the information processing apparatus 2 from the information terminal 1 but the information processing apparatus 2 may specify the delivery date and time based on the feature of the article stored in the storage unit 22. The feature of the article is, for example, a feature of the article sold on the shopping site, and is at least one of the name of the article, weight, size, shape, and whether or not the article can be loaded. In this case, the storage unit 22 stores the article information indicating the feature of each of the plurality of articles in association with the plurality of articles. The storage unit 22 stores an article database in which article identification information (hereinafter, referred to as an “article ID”) for identifying each of the plurality of articles and the article information are associated with each other. The article ID may be, for example, an article number or a model number of the article.

The article specification unit 231 acquires, for example, an article ID of a first delivery target article requested by the user U of the information terminal 1 from the information terminal 1. Subsequently, when it is specified that the first delivery target article indicated by the article ID is an article for which the user U requested delivery from the plurality of articles stored in the storage unit 22, the article specification unit 231 specifies the first feature of the first delivery target article based on the article information stored in the storage unit 22 in association with the article corresponding to the first delivery target article. For example, when it is specified that the article information associated with the article ID acquired from the information terminal 1 is included in the article database by referring to the article database, the article specification unit 231 specifies the article information associated with the article ID as the first feature of the first delivery target article.

The article specification unit 231 specifies the weight or the size of the first delivery target article, for example, by referring to the article database. The article specification unit 231 specifies the weight or the size of the first delivery target article requested to be delivered by the user U of the information terminal 1 based on the article information associated with the article ID of the first delivery target article. The time specification unit 232 specifies the delivery date and time of the flight D that can deliver the first delivery target article based on the weight or the size of the first delivery target article specified by the article specification unit 231, and the maximum load weight or the size of the container C indicated by the flying object information.

By operating the storage unit 22 and the article specification unit 231 in this way, for example, the user U who purchases an article on a shopping site can select the delivery date and time by flight D without inputting the feature of the article for which delivery is requested so that the time and effort for requesting delivery can be reduced.

### Second Modification Example

In the above explanation, the information processing apparatus 2 exemplifies the operation of specifying the delivery date and time of the flight D that delivers the delivery target article based on the feature of the delivery target article and the delivery destination but the information processing apparatus 2 may specify the delivery date and time of the flight D based on the remaining battery level of the flying object.

The article specification unit 231 further specifies the weight of a return article, which is loaded while the flying object is flying the return route from the delivery destination to the delivery source or the section from the delivery destination to a destination different from the delivery source, a distance between the delivery source and the delivery destination, or the distance between the delivery destination and the destination. The destination different from the delivery source is, for example, another delivery destination different from the delivery destination requested by the user U when the flight D flies to a plurality of delivery destinations. The weight of the return article is, for example, the weight of the article loaded at the delivery destination by the user U to return the article.

The article specification unit 231 specifies a distance between the delivery source and the delivery destination, or a distance between a destination, which is different from the delivery destination, and the delivery destination based on, for example, a location of the delivery source acquired from the flying object or the information processing apparatus such as a server that manages flight D, a location of the delivery destination, and a location of the destination different from the delivery source. The article specification unit 231 specifies the weight of the article to be loaded while the flying object is flying the return route from the delivery destination to the delivery source or the section from the delivery destination to the destination different from the delivery destination based on the information processing apparatus such as the server that manages the flight D or the weight of the article loaded at the delivery destination or the destination different from the delivery destination acquired from the flying object.

The time specification unit 232 specifies one or more dates and dines scheduled for the flight, which is specified based on the remaining battery level of the flying object, the weight of the return article, and the distance, to fly to the delivery destination. The time specification unit 232 acquires the remaining battery level of the flying object from the information processing apparatus such as a server that manages the flight D or the flying object. The time specification unit 232 specifies the amount of usage of the battery used by the flying object based on the distance the flying object flies from the delivery destination specified by the article specification unit 231 to the return to the delivery source, and the weight of the return article loaded by the flying object during the flight at that distance. When the remaining battery level of the flying object is equal to or greater than the amount of battery usage, the time specification unit 232 specifies the delivery date and time of the flight D delivered by the flying object.

By operating the article specification unit 231 and the time specification unit 232 in this way, It is possible for the time specification unit 232 to prevent delivery by the flying object with the insufficient remaining battery level. As a result, it is possible to prevent the delivery target article or the article returned by the user U from being damaged when flight D, which is selected by user U, stops flying and falls during flight.

### Effect of Information Processing Apparatus 2

As explained above, the information processing apparatus 2 includes the article specification unit 231, which specifies the delivery destination of the delivery target article desired to be delivered by the user U and the feature of the delivery target article, and the information transmission unit 233 which transmits one or more dates and times. Thereafter, the time specification unit 232 specifies one or more dates and times scheduled for the flight D, which can deliver the delivery target article and specified based on the flying object information indicating the feature of the article that can be delivered by the flying object scheduled to fly to the delivery destination and the feature of the delivery target article, to fly to the delivery destination. By operating the information processing apparatus 2 in this way, the information processing apparatus 2 can transmit the delivery date and time of the flight D that can deliver the delivery target article to the information terminal 1 used by the user U. As a result, the user U can select the delivery date and time desired by the user U.

The present invention makes it possible to contribute to Goal 9 of the United Nations-led “Sustainable Development Goals (SDGs), “Let's lay the foundation for industry and technological innovation.”

Although the present invention has been described above using the embodiments, the technical scope of the present invention is not limited to the scope described in the above-described embodiment, and various modifications and changes can be made within the scope of the gist thereof. For example, all or a part of the device can be functionally or physically distributed and integrated into any unit. Further, new embodiments resulting from any combination of the plurality of embodiments are also included in the embodiments of the present invention. The effect of the new embodiment produced by the combination has the effect of the original embodiment.

What is claimed is:

1. An information processing apparatus comprising:
an article specification unit that specifies a delivery destination of a first delivery target article which is a delivery target desired by a user, and a first feature of the first delivery target article;
a time specification unit that specifies one or more dates and times scheduled for a flight, which is specified as capable of delivering the first delivery target article based on the first feature and flying object information, to fly to the delivery destination, the flying object information indicating a feature of an article that is configured to be delivered by a flying object scheduled to fly to the delivery destination;
an information transmission unit that transmits the one or more dates and times to an information terminal of the user; and
an output unit that receives date and time information indicating a date and time selected from the one or more dates and times and outputs the received date and time information.

2. The information processing apparatus according to claim 1, wherein
the article specification unit further specifies a second feature of a second delivery target article which is another delivery target article scheduled to be delivered by the flying object, and
the time specification unit specifies one or more dates and times scheduled for the flight, which is configured to deliver the first delivery target article to the delivery destination together with the second delivery target article by comparing the first feature and the second feature with a feature indicated by the flying object information, to fly to the delivery destination.

3. The information processing apparatus according to claim 2, wherein
the article specification unit specifies a first weight or a first size of the first delivery target article, and a second weight or a second size of the second delivery target article, and
the time specification unit specifies the one or more dates and times scheduled for the flight, which is specified based on a relationship between a total weight of the first weight and the second weight, and a maximum weight of the article that is configured to be delivered by the flying object, or a relationship between a total size of the first size and the second size, and a maximum size of the article that is configured to be delivered by the flying object, to fly to the delivery destination.

4. The information processing apparatus according to claim 2, wherein
the article specification unit specifies a first shape of the first delivery target article and a second shape of the second delivery target article, and
the time specification unit specifies the one or more dates and times scheduled for the flight, which is further specified based on a relationship between the first shape and the second shape, to fly to the delivery destination.

5. The information processing apparatus according to claim 2, wherein
the article specification unit further specifies a first type of the first delivery target article and a second type of the second delivery target article, and
the time specification unit specifies the one or more dates and times scheduled for the flight, which is further specified based on whether or not the first type and the second type are types configured to be loaded, to fly to the delivery destination.

6. The information processing apparatus according to claim 1, wherein
the article specification unit specifies at least one of a first weight and a first size of the first delivery target article as the first feature, and
the time specification unit specifies the one or more dates and times scheduled for the flight, which is specified based on at least one of the first weight and the first size and at least one of a weight and a size of the article that is configured to be delivered by the flying object indicated by the flying object information, to fly to the delivery destination.

7. The information processing apparatus according to claim 1, wherein
the article specification unit further specifies a weight of a return article to be loaded while the flying object flies on a return route from the delivery destination to a delivery source or a section from the delivery destination to a destination different from the delivery source, a distance between the delivery source and the delivery destination, or a distance between the delivery destination and the destination, and
the time specification unit specifies the one or more dates and times scheduled for the flight, which is specified based on a remaining battery level of the flying object, the weight of the return article, and the distance, to fly to the delivery destination.

8. The information processing apparatus according to claim 1, wherein
among a plurality of flying objects scheduled to fly to the delivery destination, the time specification unit specifies a plurality of dates and times scheduled for a plurality of flying objects, which are configured to deliver the first delivery target article, to fly to the delivery destination, and
the information transmission unit transmits the plurality of dates and times to the information terminal.

9. The information processing apparatus according to claim 1, further comprising:
a storage unit that stores article information indicating features of each of a plurality of articles in association with the plurality of articles, wherein
the first delivery target article is an article for which the user requested delivery among the plurality of articles, and
the article specification unit specifies the first feature of the first delivery target article based on the article information stored in the storage unit in association with the article corresponding to the first delivery target article.

10. The information processing apparatus according to claim 1, further comprising:
a storage unit that stores the flying object information and the one or more dates and times which are scheduled for the flight to fly to the delivery destination, in association with each other, wherein
by referring to the flying object information and the one or more dates and times stored in the storage unit, the time specification unit specifies one or more dates and times scheduled to fly to the delivery destination.

11. An information processing method for causing a computer to execute processing of:
specifying a delivery destination of a first delivery target article which is a delivery target desired by a user, and a first feature of the first delivery target article;
specifying one or more dates and times scheduled for a flight, which is specified as capable of delivering the first delivery target article based on the first feature and flying object information, to fly to the delivery destination, the flying object information indicating a feature of an article that is configured to be delivered by a flying object scheduled to fly to the delivery destination;
transmitting the one or more dates and times to an information terminal of the user; and
receiving date and time information indicating a date and time selected from the one or more dates and times and outputting the received date and time information.

12. An information processing system comprising:
an information processing apparatus that specifies a date and time of a flight that is configured to deliver a delivery target article which is a delivery target desired by a user, to a delivery destination; and
an information terminal that selects the date and time for requesting delivery of the delivery target article among the dates and times specified by the information processing apparatus, wherein
the information processing apparatus includes
an article specification unit that specifies the delivery destination of the delivery target article and a feature of the delivery target article,
a time specification unit that specifies one or more dates and times scheduled for the flight, which is specified as capable of delivering the delivery target article based on the feature of the delivery target article and flying object information, to fly to the delivery destination the flying object information indicating a feature of an article that is configured to be delivered by a flying object scheduled to fly to the delivery destination,
an information transmission unit that transmits the one or more dates and times to the information terminal of the user, and
an output unit that receives date and time information indicating a date and time selected from the one or more dates and times and outputs the received date and time information, and
the information terminal includes
an information reception unit that receives the one or more dates and times,
a display unit that displays the received one or more dates and times, and
an information transmission unit that transmits the date and time information selected by the user among the one or more dates and times.
